(19) United States
(12) Patent Application Publication
(10) Pub. No.: US 2004/0091024 A1
(43) Pub. Date: May 13, 2004

(54) Method of searching a code space

(76) Inventor: Diego Giancola, Cambridge (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/399,435

(22) PCT Filed: Oct. 17, 2001
(86) PCT No.: PCT/GB01/04617

(30) Foreign Application Priority Data
Oct. 17, 2000 (GB) 0025494.6

(51) Int. Cl. H04B 1/707

(52) U.S. Cl. 375/148; 375/150

(57) ABSTRACT

A code space is divided into three windows of different sizes. The position of the strongest ray in the code space is called the “normal”. Two search correlators are allocated to window (1), four search correlators to window (2), and two search correlators to window (3). This allocation of the search correlators is based on an estimation of the probability of a new ray appearing in the relevant portions of the code space, relative to the normal. To begin with, the four search correlators allocated to the window (2) are controlled to occupy the normal, 0.5 chips, 1.0 chips and 1.5 chips respectively. After dwelling at their positions for 512 chips (the dwell time) each search correlator is moved four steps (two chips) along the code space. Each of the search correlators dwells at its new position for 512 chips, before again moving two chips further along the code space. Whilst the search correlators are dwelling at a position in the code space, the signal power at that position is calculated, and a signal detector acts according to the signal power so detected. When the search correlators reach the end of a window, they are moved back to the start of that window, and the search of the window is repeated. Due to the relative sizes of the windows and to the numbers of correlators assigned to those windows, the frequency of searching is different for each window.

This invention relates to a method of searching a code space for signals.

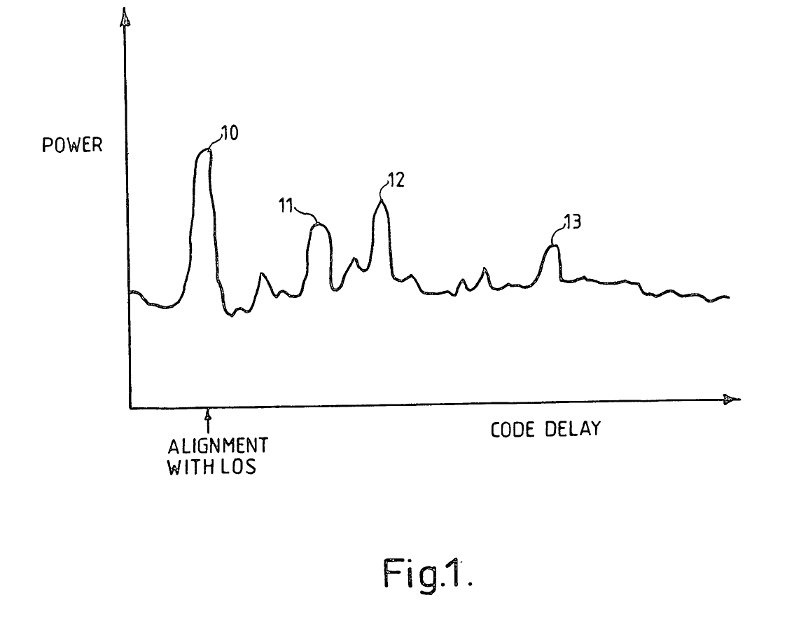

It is common in wideband code division multiple access (W-CDMA) radio receivers to use a rake receiver to process a received signal. A rake receiver comprises a number of correlators. typically four correlators, which are arranged in parallel with their outputs being applied to an adder. The output of the adder is the output signal for the rake receiver. Each correlator can be called a ‘finger’, and each finger is independently controllable. Since it is necessary to generate a pseudo-random noise (PN) code at the same frequency and phase as the code which is modulated onto the received signal to achieve correlation with a line-of-sight (LOS) signal, it is possible to isolate delayed multipath signals by mixing a delayed version of the code with the received signal. The code delay must be equal to the time delay between the LOS signal and the multipath signal for correlation to occur. In practice, due to receiver limitations and the effects of noise, a characteristic such as that shown in FIG. 1 may be obtained.

In FIG. 1, amplitude is plotted against code delay for a signal which is received over a short period in time. The LOS signal 10 is clearly visible as the strongest, since it has the largest amplitude. Multipath signals 11, 12, 13 are also visible at various places along the code delay axis, or code space, each having an amplitude independent to the others. Although not visible from this figure, each component of the signal has its own carrier phase. Each finger of the rake receiver is controlled to follow a component or ray 10-13 of the received signal. Usually, one finger follows the LOS ray 10, and the other fingers each follow a multipath ray 11-13. Often, however, the LOS ray 10 is not sufficiently strong, in which case each finger may follow a different multipath ray. A finger includes a mixer and a delay element which operate in such a way that a correlated signal is provided. The carrier phase of the correlated signal is brought to an arbitrary value, which is the same value for each finger, and the amplitude of each signal is adjusted according to a conventional algorithm. The signals from all the fingers are then added by the adder, thereby obtaining efficient signal reception from the received signal. The rake receiver, in effect, ‘rakes’ the code space for relevant rays, brings them into line with each other, in time and carrier phase, and then sums them. A rake receiver provides a significant increase in signal-to-noise ratio (SNR) compared to a receiver which operates only on the LOS ray or on a multipath ray.

As the receiver moves relative to a transmitter, such as a cellular base station, the characteristic shown in FIG. 1 changes in a number of ways. Most significantly, destructive superposition causes the power of the rays to rise and fall by very significant amounts, with the rate and frequency of the power changes being dependent particularly on the dynamics of the propagation channel. The multipath rays 11-13 also move along the code space, one way or the other, as the difference in the lengths of the signal paths change relative to the LOS path. The carrier phase of the signals also changes over time, albeit more slowly. It is currently proposed for the universal mobile telephone system (UMTS) for each base station to transmit a continuous pilot signal (a data stream of all logic “ones”) on a dedicated pilot channel, called a CPICH channel, having its own channel specific OVSF code which is modulated onto the signal at the base station. This allows hardware in a radiotelephone to track continuously signals received over the CPICH channel, to make measurements thereof and to infer from these measurements the nature of the channel and therefore how signals are propagated over the channel. Since data channels occupy the same bandwidth as the pilot channel, characteristics of the data channels can be determined without measurement of signals received over the data channels. It is proposed for the transmitter power of data channels to be controlled by the receiver (base station or radiotelephone) which receives the data channels. However, CPICH channels will be received by all radiotelephones and will, therefore, be transmitted at a constant power level.

Of course prior to tracking the rays 10-13, it is first necessary to find them. This is carried out using search correlators (not shown), which are physically distinct from the fingers used to process received signals and to demodulate data therefrom. A search correlator comprises a mixer (not shown) and a power estimator device, such as a modulus square operator device (not shown). The mixer mixes the received signal with a locally generated code having an accurately controllable phase and a code frequency matched to the code modulated onto the received signal at the transmitter.

Typically, the power of a correlated signal will be estimated over a time period corresponding to 512 chip periods of the code, this being the time for which the search correlator dwells at a particular code phase and being known as the dwell time. If the estimated power exceeds a threshold, then it is inferred that a ray is present at that position in the code space, and a finger is allocated to track that ray.

It is an aim of this invention to provide an improved method of searching a code space for signals.

In accordance with this invention, there is provided a method of searching a code space for signals, the method comprising: dividing the code space into first and second windows, each window having a width less than the width of the code space; searching, with a first correlator, only the code space within the first window; and searching, with a second correlator, only the code space within the second window.

This invention allows searching resources, e.g. correlators, to be allocated to windows in such a way that portions of the code space where the probability of there being new rays is relatively high may be allocated more searching resources than other portions of the code space. The sizes of the windows and their positions in the code space can be selected, either in the design stage or dynamically, in order to increase the speed of acquisition of new rays compared to the situation where searching is effected across the code space with uniform priority. Prioritisation may be effected by dividing the code space into windows of unequal size and/or allocating different numbers of correlators to different windows.

Embodiments of the invention will now be described, by way of example only, with reference to the accompanying drawings of which:

FIG. 1 shows a plot of amplitude versus code delay for a signal received in a typical multipath environment;

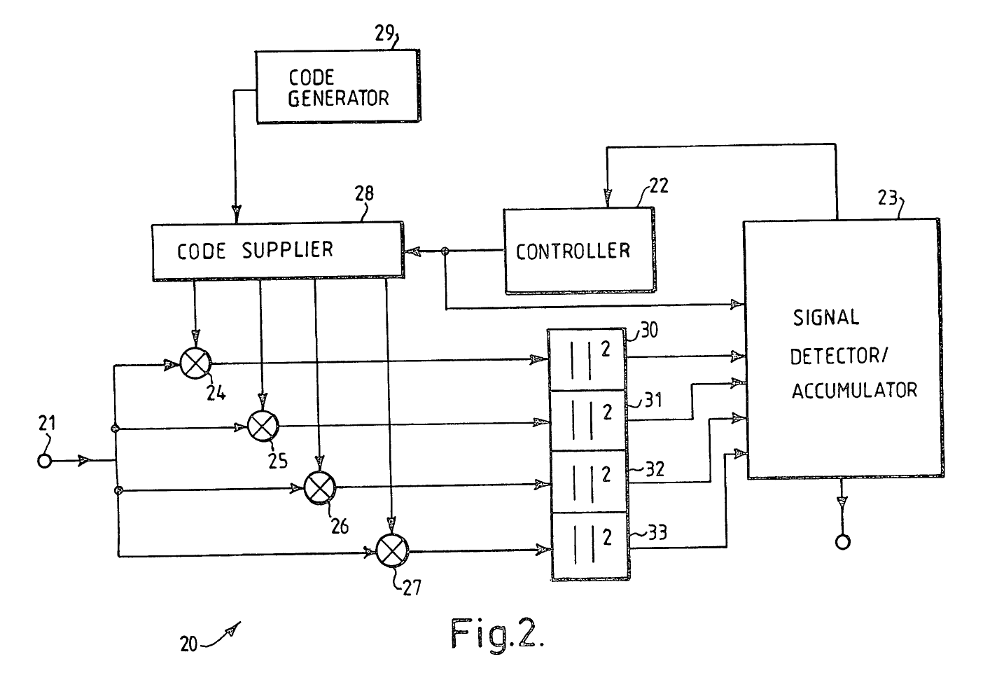

FIG. 2 shows part of a rake receiver which implements the invention;

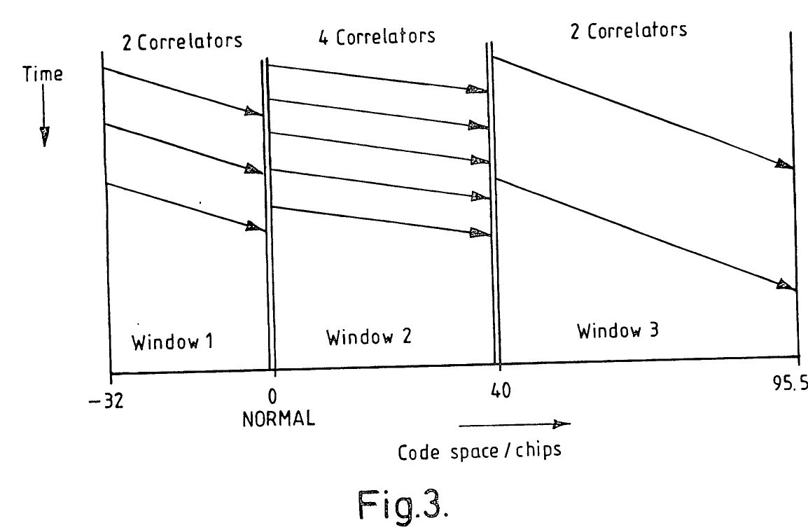

FIG. 3 shows a code space divided into three windows; and

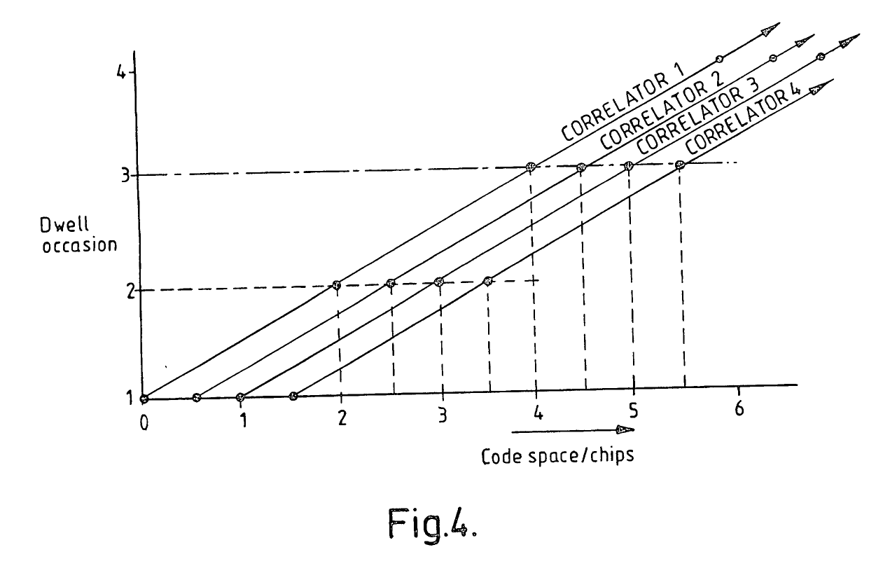

FIG. 4 shows correlators searching one of the FIG. 2 windows.

Referring to the drawings, FIG. 2 shows part of a rake receiver 20 which implements the invention. The rake receiver 2 comprises generally a signal input 21, a controller 22 and a signal detector 23. The signal input 21 is connected to a first input of each of first to fourth mixers 24-27 in parallel. Second inputs of the mixers 24-27 are connected to respective outputs of a code supplier 28, which is provided with a pseudo-random code locally generated by a code generator 29. The mixers 24-27, the code supplier 28 and the code generator 29 are shown schematically. Their effect is to provide four different signals (at the outputs of the mixers 24-27) resulting from mixing of an input signal (provided at the signal input 21), having a code modulated onto it with the same locally-generated code, the phase difference between the locally-generated code and some arbitrary part of the received signal being different for each of the four signals. The signal received at the signal input 21 is the signal received over the CPICH channel of a UMTS system. The phase of the code supplied to each of the mixers 24-27 is altered by the code supplier 28 under control of the controller 2 Control signals provided to the code supplier 28 to control the phases of the code signals provided to the mixers 24-27 are provided also to the signal detector 23 to allow the signal detector to know the code phases which relate to its other input signals. Outputs of the mixers 24-27 are connected to respective inputs of the signal detector 23 via respective modulus square operator devices 30-33, which each provide an output signal representative of the power of the signal received at its respective input. The modulus square operator devices 30-33 may be replaced by any device, in hardware or in software, which estimates the power of a signal received at its input.

Each of the mixers 24-27 together with its associated modulus square operator device 30-33 comprise a respective search correlator. Although only four search correlators are shown, eight correlators are present in this preferred implementation. Only four correlators are shown since the invention can be understood from an example utilising only four. Alternatively, four or six or any other number of correlators may be present.

The controller 99 controls the code supplier 23 to dwell on selected phases of the code for a period of time equal to 512 chip periods of the code, or 519 chips. Each of the modulus square operator devices 30-33 measures the signal power of the signals provided at its respective input, and then provides a power signal to the signal detector 23. After 512 chips have passed, the controller 22 controls the code supplier 28 to alter the phases of the codes supplied to the mixers 24-27, and the modulus square operator devices 30-33 then make signal power measurements at the new code phases. The signal detector 23 takes the signal powers received from each of the modulus square operator devices 30-33, compares them to a threshold, which is preferably dynamically adjusted according to the strengths of signals onto which fingers of the rake receiver 20 are locked, and determines therefrom which phases of the code provide signals indicative of a worthwhile ray being received at that phase of the code.

The signal detector 23 determines which received ray has the highest long term average power, and provides the location (i.e. code phase) of this ray to the controller 22. The controller 22 normalises the code space which is searched according to the position of this strongest ray. In this embodiment, the code space searched is 128 chips wide, although other widths may also be used. With the proposed UMTS system, 128 chips corresponds to 33.3 μs. Referring to FIG. 3, the controller 22 divides the code space into first, second and third windows, labelled window 1, window 2 and window 3. The window 1 is, in effect, 32 chips wide, starting at −32 chips, relative to the position of the strongest ray, and ending at −0.5 chips relative to the position of the strongest ray. The position of the strongest ray can be called the “normal”. The window 2 starts at the normal, and extends to 39.5 chips. The window 3 starts at 40 chips and extends to 95.5 chips. The windows are chosen to be multiples of 8 chips wide, since this simplifies the logic needed to implement the invention, although windows of any width may be used. The controller 22 allocates two search correlators to the window 1, four search correlators to the window 2, and two search correlators to the window 3. This allocation of the search correlators is based on an estimation of the probability of a new ray appearing in the relevant portions of the code space, relative to the normal.

Once the windows 1 to 3 have been positioned relative to the normal, the positions of the windows are not normally changed, even if the position of the strongest ray moves one way or the other along the code space. However, the controller 22 is arranged to detect when the position of the strongest ray is no longer within a predetermined distance from the normal, by detecting when a threshold has been exceeded, and then repositioning the windows around a new normal, being the position of the strongest ray once the threshold has been exceeded. Since repositioning the windows 1 to 3 is not a straightforward operation, the repositioning operation is performed as seldom as is reasonable. To this end, the predetermined threshold is set at 20 chips. However, depending on the width of the code space and on the distance between the beginning of the code space (the start of window 1) and the normal, the threshold may typically be between 10 and 30 chips. The threshold will in most circumstances be 5 chips or more.

FIG. 4 shows how the code space of the window 2 is searched by the four search correlators allocated thereto. To begin with, the four search correlators are controlled by the controller 22 to occupy the normal, 0.5 chips, 1.0 chips and 1.5 chips respectively. After dwelling at their positions for 512 chips, the dwell time, each search correlator is moved four steps, or two chips, along the code space. Each of the search correlators dwells at its new position for 512 chips, before again moving two chips further along the code space. Whilst the search correlators are dwelling at a position in the code space, the signal power at that position is calculated by the respective one of the modulus square operator devices 30-33, and the signal detector 23 acts according to the signal power so detected. Of course, where N correlators are allocated to a window, the correlators commence at adjacent steps, and each move N steps along the code space after the dwell time has expired. Although in this embodiment, the steps are equal to one half of a chip, any size step may be selected. It will be appreciated that the time taken to search every step in a window is equal to the number of steps in the window multiplied by the dwell time divided by the number of correlators allocated to the window. When the search correlators reach the end of a window, the controller 22 moves the search correlators back to the start of that window, and the search of the window is repeated.

Referring again to FIG. 3, the searching of the windows 1 to 3 is indicated schematically by the arrows shown pointing to the right and slightly downwardly. These arrows indicate the regularity of the windows being searched, with the vertical axis representing time, moving downwardly.

It will be seen that, due to the relative sizes of the windows 1 to 3, and to the numbers of correlators assigned to those windows, the window 2 is searched more frequently than the window 1, which in turn is searched more frequently than the window 3.

In a preferred implementation, the signal detector/accumulator 23 contains a memory (not shown) and a processor (not shown). The processor is arranged to store, in the memory, the signal power estimations provided by the modulus square operator devices 30-33. The processor is arranged also to sum the signal power estimations obtained from one position in the code space over P dwell times from P sweeps of the window. The value of P is adjustable depending on the dynamics of the channel between the transmitter (not shown) and the receiver 20 as estimated by a channel dynamics estimator device (not shown). The skilled person will know how to build a channel dynamics estimator device. The sum of the signal power estimations is divided by P to form a running average. It will be appreciated that averaging in this way constitutes non-coherent accumulation of the signals.

When low channel dynamics are deduced (i.e. the channel is detected as changing only slowly), the value of P is selected to be high. When high channel dynamics are deduced, a high value of P is detected. For example where the receiver 20 is fast moving in an urban environment, a value of ten may be selected for P, falling to P=1 for a stationary receiver in an environment where there are no large moving objects which may cause time-varying multipath signals. The primary advantage of dynamic adjustment of the non-coherent accumulation in this way is that strong rays are more likely to be picked up in high dynamics situations, although a faster response time is possible in low dynamics situations.

In another embodiment, the dwell time is adjustable in dependence on the SNR or signal-to-interference ratio (SIR) of the received signal. In this embodiment, the controller 22 estimates the SIR of the received signal (SIR estimation is a known technique) and controls the code supplier 28 to adopt dwell times suitable for the conditions. Where a high SIR is detected, the dwell time need not be very long, since it can be assumed that a good measure of power can be made in a relatively short period of time—where the SIR is particularly high, for example when very few users are operating in the bandwidth of the received signal, the dwell time corresponds to only 256 chips. On the other hand, when the SIR is relatively low, for example when there are many users operating in the bandwidth of the receiver, the controller 22 controls the code supplier 28 to dwell at each position in the code space for 1028 chips. In this latter case, a more accurate power estimation may be achieved, whereas this may not be necessary in high SIR environments.

Dynamic adjustment of the dwell time in this way can be distinguished from accumulation of plural dwell occasions since accumulation is coherent over a dwell period, whereas accumulation is non-coherent when signal power estimates are accumulated over plural dwell occasions.

1. A method of searching a code space for signals, the method comprising:
dividing the code space into first and second windows, each window having a width less than the width of the code space;
searching, with N first correlators, when N is an integer greater than 1, only the code space within the first window and searching, with a second correlator, only the code space within a second window, the first window being divided into M points, where M is an integer greater than N, the N correlators being placed at adjacent points, and subsequently each correlator being moved N points along the first window;
detecting which of a number of received signals has the highest average signal strength, and allocating positions in the code space to the windows, the positions being relative to the position of the signal so detected;
detecting when the strongest signal has moved from its position when the positions of the windows were last allocated by an amount exceeding a threshold, the threshold exceeding five chip periods of the code; and
in response to a positive detection, reallocating the windows positions in the code space relative to the new position of the strongest signal.

2. A method according to claim 1 in which the windows are contiguous and non-overlapping.

3. A method according to claim 1 or claim 2, in which the N correlators are moved along the first window substantially simultaneously.

4. A method according to any one of claims 1 to 3, in which the threshold is between ten and thirty chip periods of the code.

5. A method according to any one of claims 1 to 4, further comprising estimating the SIR of a received signal, and adjusting the dwell time of the correlators at positions in the code space on the basis of the estimated SIR.

6. A method according to any one of claims 1 to 5, further comprising non-coherently accumulating signal strength measurements for a position in the code space over a plurality of occasions on which the position is dwelled upon by one or more search correlators.

7. A method according to claim 6, further comprising adjusting the number of signal strength measurements which are non-coherently accumulated.

8. A method according to claim 7, further comprising deducing a measure of the dynamics of a channel over which signals are received, and adjusting the number of signal strength measurements which are non-coherently accumulated on the basis of the deduced dynamics.

9. A method of searching a code space for signals, the method comprising:
dividing the code space into first and second windows, each window having a width less than the width of the code space;
searching, with N first correlators, where N is an integer greater than 1, only the code space within the first window, and searching, with a second correlator, only the code space within a second window, the first window being divided into M points, where M is an integer greater than N, the correlators being placed at adjacent points, and subsequently each correlator being moved N points along the first window; and
non-coherently accumulating signal strength measurements for a position in the code space over a plurality of occasions on which the position is dwelled upon by one or more search correlators.

10. A method according to claim 9, in which the windows are contiguous and non-overlapping.

11. A method according to claim 9 or claim 10, in which the N correlators are moved along the first window substantially simultaneously.

12. A method according to any one of claims 9 to 11, further comprising: detecting which of a number of received signals has the highest average signal strength, and allocating positions in the code space to the windows, the positions being relative to the position of the signal so detected.

13. A method according to claim 12, further comprising tracking the strongest signal; detecting when the strongest signal has moved from its position when the positions of the windows were last allocated by an amount exceeding a threshold, the threshold exceeding five chip periods of the code; and, in response to a positive detection, reallocating the windows positions in the code space relative to the new position of the strongest signal.

14. A method according to claim 13, in which the threshold is between 10 and thirty chip periods of the code.

15. A method according to any one of claims 9 to 14, further comprising adjusting the number of signal strength measurements which are non-coherently accumulated.

16. A method according to claim 15, further comprising deducing a measure of the dynamics of a channel over which signals are received, and adjusting the number of signal strength measurements which are non-coherently accumulated on the basis of the deduced dynamics.

17. A method according to any one of claims 9 to 16, further comprising estimating the SIR of a received signal, and adjusting the dwell time of the correlators at positions in the code space on the basis of the estimated SIR.
